(19) United States
(12) Patent Application Publication
(10) Pub. No.: US 2017/0004162 A1
(43) Pub. Date: Jan. 5, 2017

(54) DATA LOGGER CAPABLE OF SAVING COLLECTED DATA IN SEPARATE STORAGE MEDIA DATUM BY DATUM

(71) Applicant: FANUC Corporation, Yamanashi (JP)

(72) Inventors: Yoshitaka OGAWA, Yamanashi (JP); Shogo INOUE, Yamanashi (JP)

(21) Appl. No.: 15/197,817

(22) Filed: Jun. 30, 2016

(30) Foreign Application Priority Data
Jul. 1, 2015 (JP) 2015-132366

(51) Int. Cl. G06F 17/30; G06F 3/06

(52) U.S. Cl. CPC G06F 17/30339; G06F 3/0619; G06F 3/0656; G06F 3/0683

(57) ABSTRACT

A data logger saves data, collected from outside on a regular basis or at predetermined timing, in any of a plurality of storage media the data logger includes, in accordance with an attribute conforming to types of the data.

### BACKGROUND OF THE INVENTION

1. Field of the Invention

The present invention relates to a data logger and particularly relates to a data logger that enables saving collected data, datum by datum, in appropriate storage media.

2. Description of the Related Art

Conventionally, a data logger saves all collected data in the same storage medium. According to Japanese Patent Application Laid-Open No. 2010-066901, for instance, data concerning controlled equipment that are temporarily saved in a buffer in control equipment are acquired by a programmable display unit and all the acquired data are saved in a buffer in the programmable display unit.

Data that are collected by a data logger have characteristics different thereamong in cycle of collection, degree of importance, and the like. Storage media in which the collected data are saved have characteristics different thereamong in restriction on number of times of writing, replaceability, and the like. Therefore, saving all the collected data in the same storage medium reduces reliability, maintainability, and the like of the data logger.

For instance, a datum that is collected in a short cycle is written a greater number of times into the storage medium than a datum that is collected in a long cycle. Thus a load on such a storage medium is made heavier and a risk of breakage of the storage medium is therefore made higher. Saving data that are collected in a short cycle and data that are collected in a long cycle in the same storage medium increases the risk of breakage of the storage medium for the data that impose a lower load on the storage medium as well.

Use of a storage medium with the restriction on the number of times of writing increases a risk that the storage medium early comes to end of a life for writing thereof because data that are collected in short cycles are written the greater number of times into the storage medium. Saving data that are collected in short cycles and data that are collected in long cycles in the same storage medium increases the risk that the storage medium early comes to the end of the life for writing thereof, for the data that involve a lower risk that the storage medium comes to the end of the life for writing as well. The number of times of writing into a storage medium depends not only on the cycle of data collection but also on amount of data to be collected.

### SUMMARY OF THE INVENTION

An object of the present invention is to provide a data logger that enables saving collected data, datum by datum, in appropriate storage media.

The data logger according to the invention collects data acquired from a controlled device, saves the collected data in storage media, and includes the plurality of storage media and a data collection processing unit that collects the data from outside on a regular basis or at predetermined timing. The data collection processing unit includes a data acquisition processing unit that acquires the data from the outside and a data saving processing unit that saves the data acquired by the data acquisition processing unit in any of the plurality of storage media in accordance with an attribute based on types of the data.

The data collection processing unit may further include a storage media designation processing unit that designates storage media out of the plurality of storage media in which the data acquired by the data acquisition processing unit are to be saved in accordance with the attribute based on the types of the data and the data saving processing unit may be configured to save the data in the storage media designated by the storage media designation processing unit.

A data logger system according to the invention is composed of the data logger, the controlled device, and a controller that controls the controlled device. The controller includes a buffer and a data storage processing unit that acquires data from the controlled device, adds an attribute, based on types of the acquired data, to the data, and stores the data in the buffer. The data acquisition processing unit is configured to acquire the data stored in the buffer. The data saving processing unit is configured to save the data in any of the plurality of storage media in accordance with the attribute added to the data by the data storage processing unit.

According to the invention, saving the collected data, datum by datum, in the appropriate storage media enables constructing the data logger that has high reliability and that is easy to maintain.

### BRIEF DESCRIPTION OF THE DRAWINGS

The above and other objects and features of this invention will become apparent from the following description on embodiments with reference to the accompanying drawings, in which:

FIG. 1 is a schematic block diagram illustrating a data logger system according to a first embodiment of the invention;

FIGS. 2A and 2B are diagrams illustrating methods of adding attributes to data by a controller that forms the data logger system of FIG. 1;

FIG. 3 is a flow chart illustrating a flow of processing that is executed on a data storage processing unit in the data logger system of FIG. 1;

FIG. 4 is a flow chart illustrating a flow of processing that is executed on a data collection processing unit in a data logger that forms the data logger system of FIG. 1;

FIG. 5 is a schematic block diagram illustrating a data logger system according to a second embodiment of the invention;

FIG. 6 is a diagram illustrating an example of a storage media designation table in a data logger that forms the data logger system of FIG. 5;

FIG. 7 is an example of a storage media management table in the data logger that forms the data logger system of FIG. 5;

FIG. 8 is a flow chart illustrating a flow of processing that is executed on a storage media designation processing unit in the data logger that forms the data logger system of FIG. 5;

FIG. 9 is a flow chart illustrating a flow of processing that is executed on a data storage processing unit in a controller that forms the data logger system of FIG. 5;

FIG. 10 is a flow chart illustrating a flow of processing that is executed on a data collection processing unit in the data logger that forms the data logger system of FIG. 5; and

FIG. 11 is an example of principles for saving of data in the data logger system of FIG. 5.

### DETAILED DESCRIPTION OF THE PREFERRED EMBODIMENTS

The invention resolves above problems of the prior art techniques by providing a plurality of storage media in which collected data are to be saved, saving the collected data, datum by datum, in appropriate storage media, saving the data in designated storage media, and the like. Designation of a storage medium for saving each collected datum is attained by use of rules by which an attribute is added to data, various tables (such as “storage media designation table” and “storage media management table”) in which relations between types of the collected data and the storage media for saving the data are described, and/or the like and by saving of each datum in a storage medium in accordance with the rules, the tables, and/or the like.

The terms “storage media” and “storage medium” in the invention denote overall media capable of storing data, including media, such as HDD and Flash ROM, which are to be fixed to a device, media, such as floppy (registered trademark) disc, MO disc, CF card, and SD card, which are comparatively easy to replace, write-once recording medium such as CD-R, DVD-R, and BD-R, and network storage which is accessible through a network, and areas on the same medium which can be recognized as different areas from a program (such as areas in different partitions on a disc and different shared areas provided on network storage) may be each treated as one storage medium.

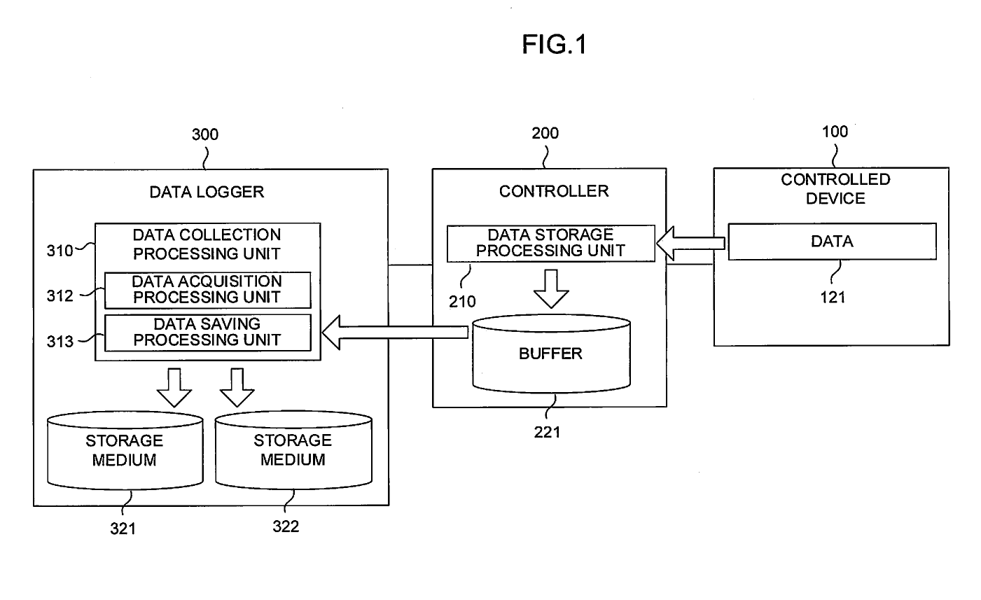

Initially, a first embodiment of a data logger system according to the invention will be described with reference to FIGS. 1 through 4.

FIG. 1 is a schematic block diagram illustrating the data logger system according to the embodiment.

The data logger system adds an attribute to collected data, designates storage media to be stored with the data based on the added attribute, and includes a controlled device 100, a controller 200, and a data logger 300, as illustrated in FIG. 1.

The controlled device 100 is equipment or a device that can be controlled by the controller 200 and may be a machine tool, an industrial machine, a robot, or the like. The controlled device 100 has a function of outputting coordinate values and velocity values of driving parts during operation, setting values for configurations, and data (data 121) acquired from sensors such as ammeter/voltmeter and load measuring instrument, not illustrated, in response to requests from outside or spontaneously. The data 121 the controlled device 100 outputs have data formats that enable discrimination among types of the data or are configured so as to enable the discrimination among the types of the data.

The controller 200 is equipment or a device that controls the controlled device 100 and may be a CNC, a PLC, an RC (robot controller), or the like. The data logger 300 and the controller 200 may be connected via an internal bus or via a network such as Ethernet (registered trademark).

The controller 200 includes a data storage processing unit 210 and a buffer 221. The data storage processing unit 210 acquires a plurality of data 121 outputted from the controlled device 100 and temporarily stores the data, datum by datum, in the buffer 221. The data storage processing unit 210 has a function of adding the attribute to the data when storing the data in the buffer 221. The buffer 221 is an area provided on a storage device, such as memory and HDD, the controller 200 includes.

The data storage processing unit 210 adds the attribute in accordance with cycles of collection, amounts to be collected, degrees of importance, and/or the like of the data. Attribute addition rules for addition of the attribute to the data have been set in the controller 200 in advance and the data storage processing unit 210 adds the attribute to the data based on the rules that have been set.

The attribute addition rules are defined by attributes that may be added to the data in accordance with conditions such as the types of the data. The conditions such as the types of the data include “positions and actual velocities of feed shafts”, “number of rotation of and load on main spindle”, “lives of tools”, “battery lives in CNC and amplifiers”, and/or the like, for instance. The attributes that may be added to the data include “cycle of collection”, “degree of importance”, “amount to be collected”, and/or the like.

What rules are to be formulated and stored in the controller 200 in advance is determined depending on what points are considered on the system the controller 200 belongs to for distribution of the data among storage destinations. In such formulated rules, for instance, the attribute “cycle of collection” is prepared when the data is to be distributed among and saved in different storage media in consideration of the cycle of collection of the data, and

An attribute value A is set in the attribute “cycle of collection” for data types such as “positions and actual velocities of feed shafts” and “number of rotation of and load on main spindle” that are collected in short cycles (cycles between 1 ms and 500 ms), or

An attribute value B is set in the attribute “cycle of collection” for data types such as “lives of tools” that are collected in long cycles (once a day or on occasions when rarely frequent events occur).

A number of attribute values to be set is preferably determined in consideration of a number of destination storage media among which the data are to be distributed for storage.

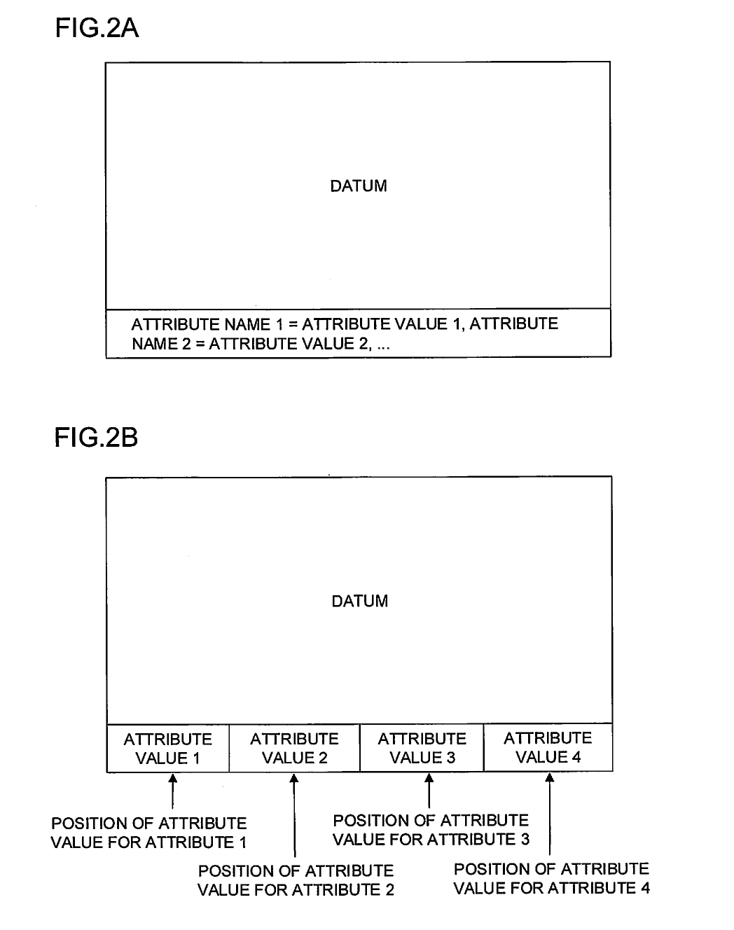

As for a method of adding the attributes to the data, the attributes in form of “attribute name =attribute value” may be added to each datum as illustrated in FIG. 2A or a plurality of attribute value fields each having a fixed width may be added to each datum and only attribute values may be added to the datum with correspondence between types of the attributes and positions of the attribute value fields as illustrated in FIG. 2B, for instance. Any method of adding may be employed as long as the data logger 300 can grasp the attribute added to the data when referring to the data afterward.

The data logger 300 is a device that has functions of collecting data from an external device (not illustrated) having wired or wireless connection therewith and storing the collected data in storage media. The data logger 300 may be configured as a data logger device, an extension board, or peripheral equipment for exclusive use or may be configured by operation of software on a general-purpose computer.

One or more storage media (first and second two storage media 321, 322 in FIG. 1) can be connected to the data logger 300 in a wired or wireless manner and reading and writing can be performed for the connected storage media 321, 322 separately as different storage media on the data logger 3010. The storage media connected to the data logger 300, such as a HDD, Flash ROM and the like that are each fixed to a device and are not easy to replace and a CF card, SD card and the like that have predetermined lives for writing but are comparatively easy to replace, has characteristics according to properties, status of use and the like of the media. Types of data suitable for saving differ according to the characteristics of the storage media; for example, media easy to replace are suitable for data prone to be large in amount due to short cycle of collection.

The data logger 300 includes a data collection processing unit 310. The data collection processing unit 310 collects the data stored in the buffer 221 provided in the controller 200 connected to the data collection processing unit 310, designates destination storage media to be stored with the collected data, and stores the data in the storage media designated as the destinations. The data collection processing unit 310 includes a data acquisition processing unit 312 and a data saving processing unit 313.

The data acquisition processing unit 312 acquires the data stored in the buffer 221 provided in the controller 200, in accordance with commands from the data collection processing unit 310. Acquisition of the data by the data acquisition processing unit 312 depends on a manner of connection between the controller 200 and the data logger 300. For instance, in case where the controller 200 and the data logger 300 are connected via an internal bus, the data are acquired with use of data transfer commands or the like, whereas in case where the controller 200 and the data logger 300 are connected via a network, the data are acquired with use of file transfer commands for protocols such as FTP and HTTP.

In accordance with the attribute added to the data the data acquisition processing unit 312 has acquired from the buffer 221 of the controller 200, the data saving processing unit 313 designates the destination storage media to be stored with the data from among the storage media (storage medium 321 and storage medium 322 in FIG. 1) connected to the data logger 300 and saves the data in the designated storage media.

The destination storage media to be stored with the data are designated by the data saving processing unit 313 based on storage destination designation rules for destination of the destination storage media that have been set in advance in the data logger 300. The storage destination designation rules are defined by destination storage media to be stored with data in accordance with conditions on the attributes. For instance, such rules are defined as follows.

In case where the attribute “cycle of collection” in which the attribute value A is set is added to an acquired datum, the first storage medium 321 is designated as the destination storage medium to be stored with the datum.

In case where the attribute “cycle of collection” in which the attribute value B is set is added to an acquired datum, the second storage medium 322 is designated as the destination storage medium to be stored with the datum.

With setting of the storage destination designation rules in consideration of the attribute addition rules set in the controller 200, data of various data types can be saved in storage media that are respectively suited to store the data. In case where the first storage medium 321 is a CF card and where the second storage medium 322 is a Flash ROM, for instance, respective setting of the above rules in the controller 200 and the data logger 300 causes such data as “positions and actual velocities of feed shafts” and “number of rotation of and load on main spindle” that are collected in short cycles (cycle between 1 ms and 500 ms) to be stored in the CF card which is comparatively easy to replace and obtain and causes such data as “lives of tools” that are collected in long cycles (once a day or on occasions when rarely frequent events occur) to be stored in the Flash ROM replacement of which consumes much time (no problem is caused by storage in a storage medium which is not easy to replace because such data rarely increases).

The data collection processing unit 310 makes the data acquisition processing unit 312 and the data saving processing unit 313 operate in a predetermined cycle or in response to signals, operations by a user, or the like, thereby collects the data stored in the buffer 221 of the controller 200, and saves the data in the storage media that are respectively suited to saving of the data.

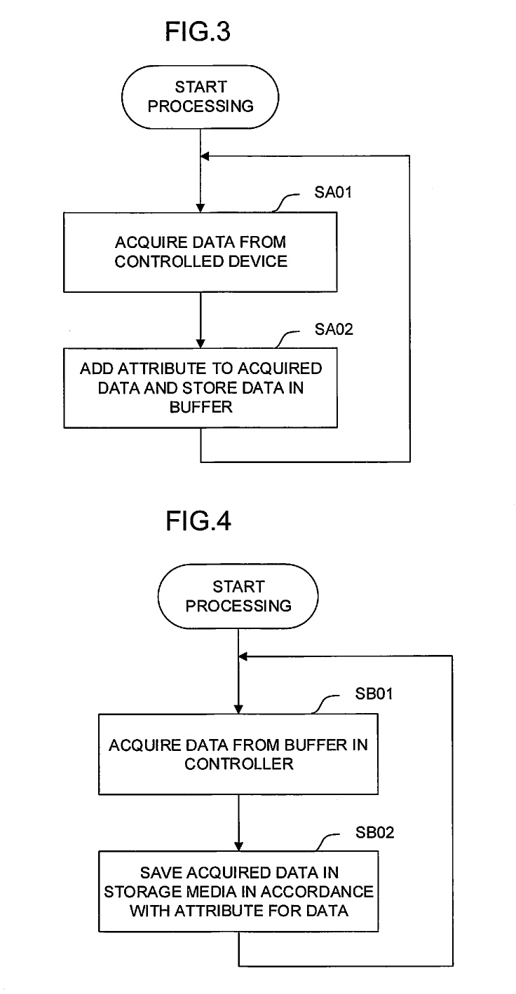

FIG. 3 is a flow chart illustrating a flow of processing that is executed on the data storage processing unit 210 in the controller 200.

[Step SA01] The data storage processing unit 210 acquires the data in the controlled device 100.

[Step SA02] The data storage processing unit 210 adds an attribute to the data acquired from the controlled device 100 and temporarily stores the data in the buffer 221. Once such storage is completed, the flow returns to step SA01.

FIG. 4 is a flow chart illustrating a flow of processing that is executed on the data collection processing unit 310 in the data logger 300.

[Step SB01] The data acquisition processing unit 312 acquires the data from the buffer 221 in the controller 200.

[Step SB02] The data saving processing unit 313 designates the destination storage media (storage media 321, 322) to be stored with the data acquired in step SB01 in accordance with the attribute added to the data and saves the data in the designated storage media. Once such saving is completed, the flow returns to step SB01.

As described above, the data logger 300 illustrated in FIG. 1 is capable of designating the destination storage media to be stored with the data based on the attribute added to the data by the controller 200 and saving the data in the designated storage media. Setting the rules such that the storage in the storage media suited to the data is carried out based on the attribute added to the data by the controller 200 enables constructing the data logger that has high reliability and ease of maintenance.

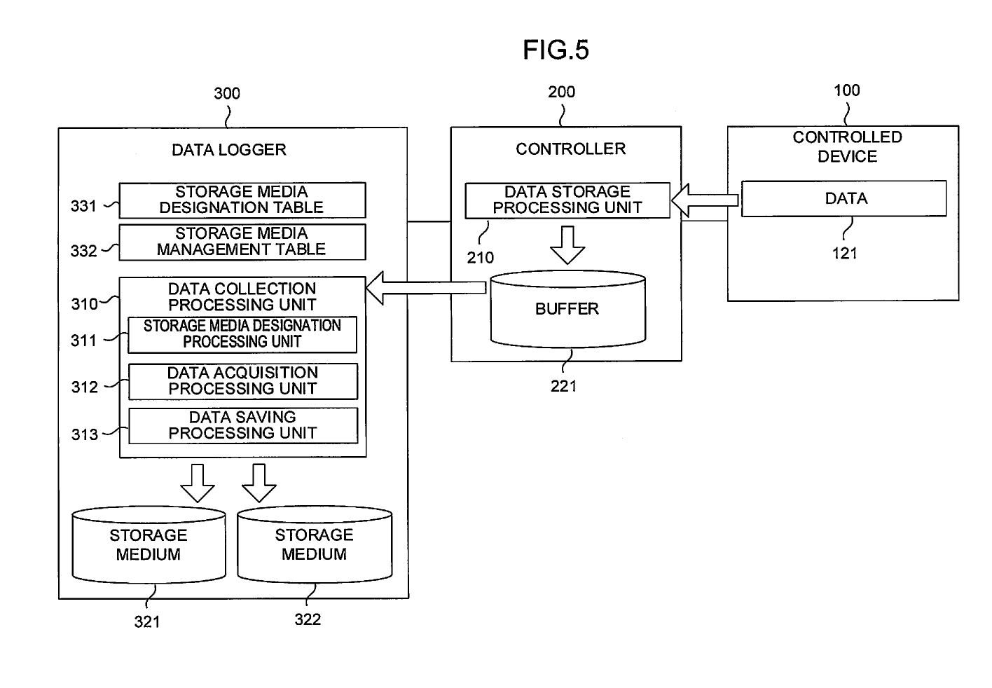

Subsequently, a second embodiment of a data logger system according to the invention will be described with reference to FIGS. 5 through 11.

In the first embodiment, an attribute is added to the collected data and the storage media to be stored with the data are designated based on the added attribute. In the second embodiment, discrimination among types of data or the like is made on the data logger and storage media to be stored with the data are designated in accordance with results of the discrimination.

FIG. 5 is a schematic block diagram illustrating a data logger system according to the second embodiment. The data logger system includes the controlled device 100, the controller 200, and the data logger 300.

The controlled device 100 is equipment or a device that can be controlled by the controller 200, as is the case with the first embodiment, and has the function of outputting the data (data 121) acquired during operation in response to requests from outside or spontaneously. The data 121 the controlled device 100 outputs have data formats that enable the discrimination among the types of the data or are configured so as to enable the discrimination among the types of the data.

The controller 200 is equipment or a device that controls the controlled device 100, as is the case with the first embodiment, and includes the data storage processing unit 210 and the buffer 221. The data storage processing unit 210 acquires a plurality of data 121 outputted from the controlled device 100 and temporarily stores the data, datum by datum, in the buffer 221. When storing the data in the buffer 221, the data storage processing unit 210 stores the data as they are, without adding an attribute to the data, in contrast to the first embodiment.

The data logger 300 is a device that has functions of collecting data from an external device (not illustrated) having wired or wireless connection therewith and storing the collected data in storage media. One or more storage media (first and second two storage media 321, 322 in FIG. 5) can be connected to the data logger 300 in a wired or wireless manner, as is the case with the first embodiment.

The data logger 300 includes the data collection processing unit 310. The data collection processing unit 310 collects the data stored in the buffer 221 provided in the controller 200 connected to the data collection processing unit 310, designates destination storage media to be stored with the collected data, and stores the data in the respective storage media designated as the destinations. The data collection processing unit 310 includes a storage media designation processing unit 311, the data acquisition processing unit 312, and the data saving processing unit 313.

The storage media designation processing unit 311 has a function of determining whether or not to designate the storage media for saving of the collected data with reference to a storage media designation table 331 and a storage media management table 332.

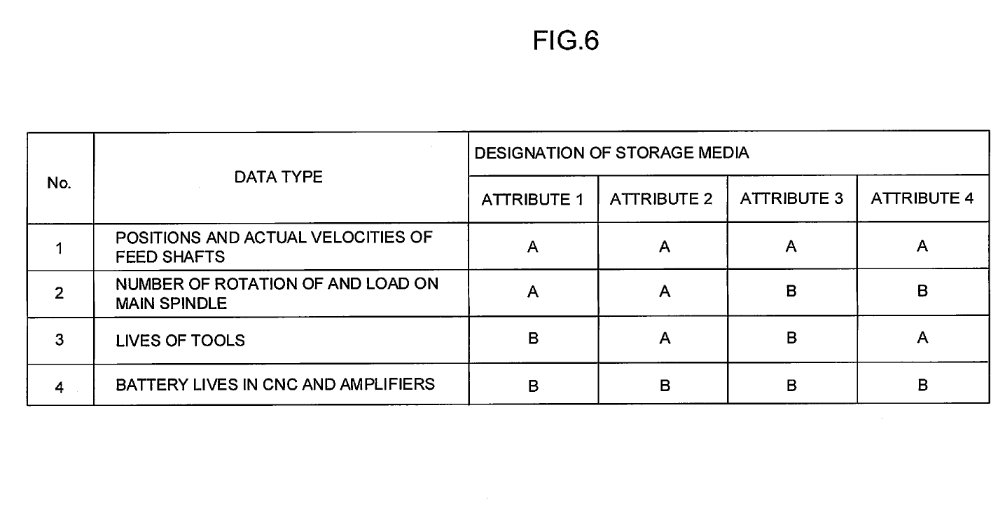

FIG. 6 illustrates an example of the storage media designation table 331 in the data logger 300 of FIG. 5.

The storage media designation table 331, which is a table for designation of storage media in accordance with types and attributes of data, prepares an attribute for each common characteristic among types of data, and designates a storage medium ID specifying a destination storage medium for saving for each attribute. In the example illustrated in FIG. 6, for instance, the storage media are designated in accordance with the types and attributes of data. The storage media designation table 331 illustrated in FIG. 6 is illustrative only and the types of data, a number of the attributes, and the like in the table are not limited thereto.

Attribute 1: Distribution among storage media for saving in accordance with cycles of data collection

A storage medium ID “N” is designated when a datum that is collected in a short cycle (cycle between 1 ms and 500 ms) is saved or a storage medium ID “B” is designated when a datum that is collected in a long cycle (once a day or on occasions when rarely frequent events occur) is saved.

Attribute 2: Distribution among storage media for saving in accordance with degrees of importance of data

The storage medium ID “A” is designated when a datum with a high degree of importance is saved or the storage medium ID “B” is designated when a datum with a low degree of importance is saved.

Attribute 3: Distribution among storage media for saving in accordance with amounts of data to be collected

The storage medium ID “A” is designated when a datum for which a large amount of items are to be collected is saved or the storage medium ID “B” is designated when a datum for which a small amount of items are to be collected is fsaved.

Attribute 4: Designation of storage media at user' discretion

A user designates the storage medium ID “A” or “B” at his/her discretion.

When the storage media designation processing unit 311 designates a destination storage medium to be stored with a datum with reference to the storage media designation table 331, the storage media designation processing unit 311 uses a predetermined attribute in conformity with a purpose. The attribute to be used can be designated in accordance with setting or the like by the user. In cases where the distribution among the storage media for saving is carried out in accordance with the cycles of data collection, for instance, the attribute 1 in the storage media designation table 331 is used. Then the storage medium ID “A” is designated for the data types “positions and actual velocities of feed shafts” and “number of rotation of and load on main spindle” whereas the storage medium ID “B” is designated for the data types “lives of tools” and “battery lives in CNC and amplifiers”.

Once a storage medium ID is designated for each datum through above processing, the storage media designation processing unit 311 subsequently specifies the storage medium for saving of the datum with reference to the storage media management table 332.

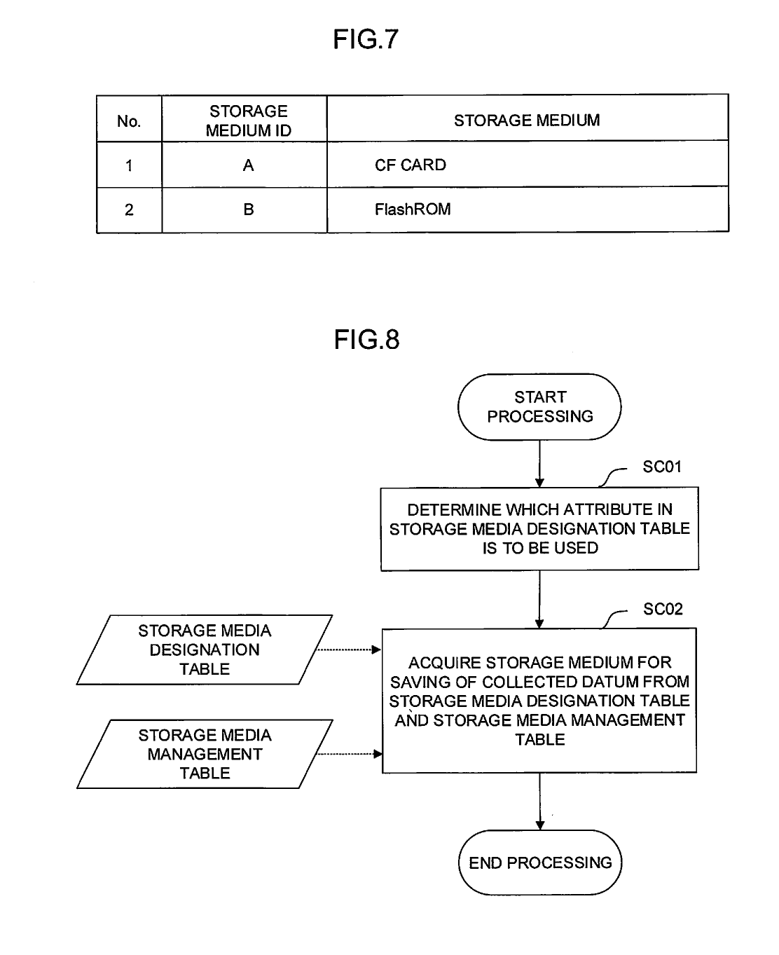

FIG. 7 illustrates an example of the storage media management table 332 in the data logger 300 of FIG. 5.

In the storage media management table 332, storage media accessible from the data logger 300 are stored in association with the storage medium IDs. In the example of FIG. 7, the storage medium ID “A” is designated when a CF card is used as the storage medium whereas the storage medium ID “B” is designated when a Flash ROM is used as the storage medium. The storage media management table 332 of FIG. 7 is illustrative only and storage media that can be managed on the storage media management table 332 are not limited thereto.

The data acquisition processing unit 312 acquires data stored in the buffer 221 provided in the controller 200, in accordance with commands from the data collection processing unit 310, as is the case with the first embodiment. The data saving processing unit 313 makes the storage media designation processing unit 311 specify destination storage media to be stored with the data acquired by the data acquisition processing unit 312 from the buffer 221 of the controller 200 and saves the data in the specified storage media as the destination storage media.

When the destination storage media are determined based on the attribute 1 (cycle of collection) in case where the first storage medium 321 is a CF card and where the second storage medium 322 is a Flash ROM in FIG. 5, for instance, the storage medium ID “A” is designated for such data as “positions and actual velocities of feed shafts” and “number of rotation of and load on main spindle” with reference to the storage media designation table 331, and, based on the designated storage medium ID (=A), the CF card is acquired as the storage medium with reference to the storage media management table 332, so that the data are saved in the first storage medium 321. On the other hand, the storage medium ID “B” is designated for such data as “lives of tools ” and “battery lives in CNC and amplifiers” with reference to the storage media designation table 331 and, based on the designated storage medium ID (=B), the Flash ROM is acquired as the storage medium with reference to the storage media management table 332, so that the data are saved in the second storage medium 322.

FIG. 8 is a flow chart illustrating a flow of processing that is executed on the storage media designation processing unit 311 in the data logger 300.

[Step SC01] The storage media designation processing unit 311 determines which attribute in the storage media designation table 331 is to be used for the designation of the storage medium for saving of the collected datum, based on the setting by the user or the like.

[Step SC02] The storage media designation processing unit 311 acquires the storage medium for saving of the collected datum from the storage media designation table 331 and the storage media management table 332.

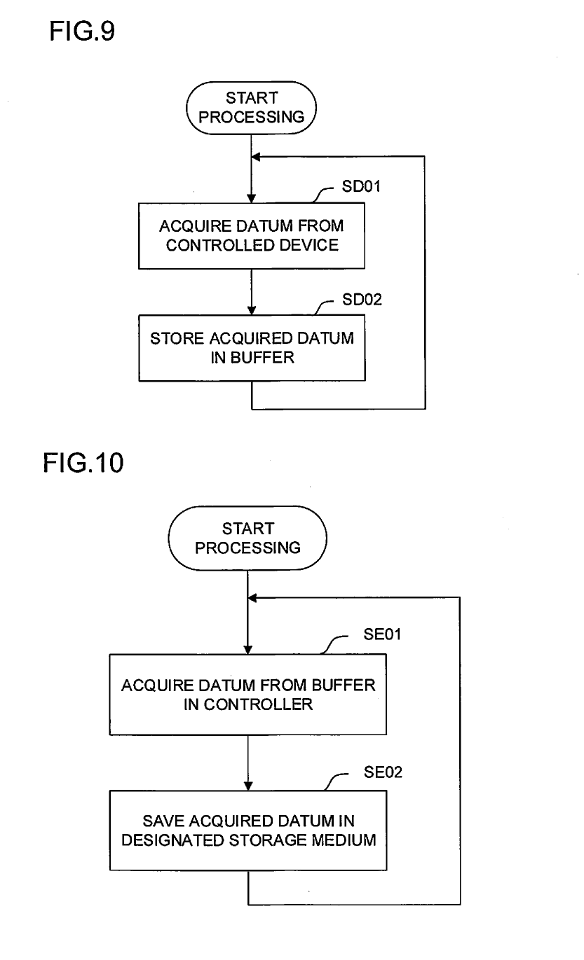

FIG. 9 is a flow chart illustrating a flow of processing that is executed on the data storage processing unit 210 in the controller 200.

[Step SD01] The data storage processing unit 210 acquires a datum in the controlled device 100.

[Step SD02] The data storage processing unit 210 temporarily stores the datum, acquired from the controlled device 100, in the buffer 221. Once such storage is completed, the flow returns to step SD01.

FIG. 10 is a flow chart illustrating a flow of processing that is executed on the data collection processing unit 310 in the data logger 300.

[Step SE01] The data acquisition processing unit 312 acquires the datum from the buffer 221 in the controller 200.

[Step SE02] The data saving processing unit 313 makes the storage media designation processing unit 311 specify the destination storage medium to be stored with the datum acquired in step SE01 and saves the datum in the specified storage medium (storage medium 321 or storage medium 322). Once such saving is completed, the flow returns to step SE01.

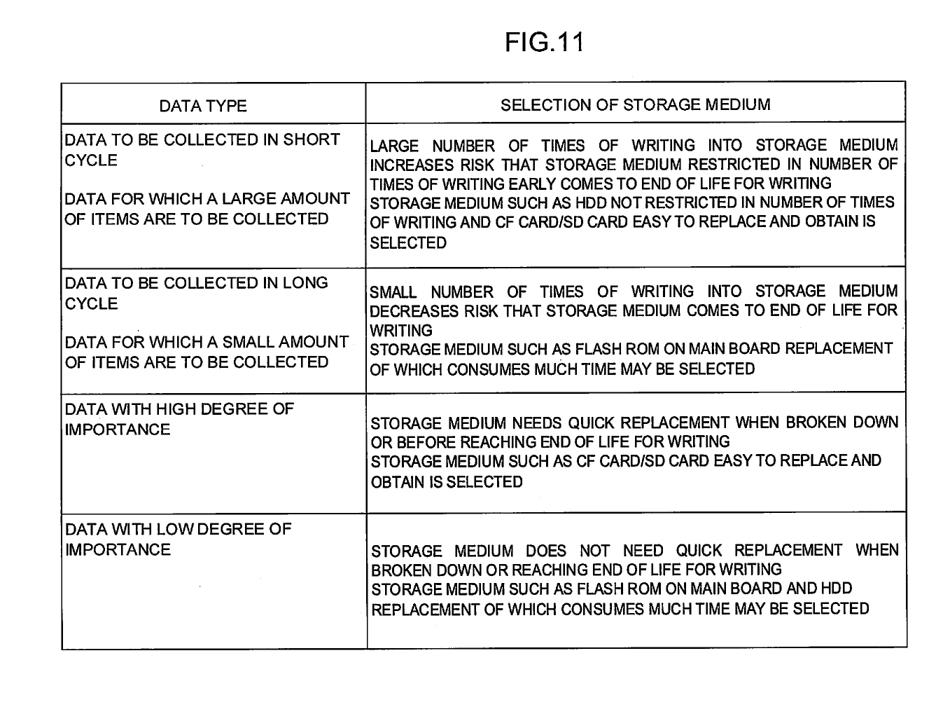

Through above processing, the data acquired by the data acquisition processing unit 312 can be saved in appropriate storage media for which the designated attribute is considered, based on the types of the data. Values in the storage media designation table 331 and the storage media management table 332 are preferably set based on principles for saving of data that are illustrated as an example in FIG. 11 or the like, for instance.

As described above, the data logger 300 of the embodiment is capable of specifying the storage media from the storage media designation table 331 and the storage media management table 332 based on the types of the data acquired from the controller 200 and saving the data in the specified storage media. The user of the data logger 300 is thus enabled to easily change a destination storage medium for saving by selecting an attribute as a basis for designation of the storage medium. In addition, the user is enabled to easily change the storage medium for saving by changing designation of storage media in the storage media designation table 331 or changing the values in the storage media management table 332.

Though the embodiments of the invention have been described above, the invention is not limited to the embodiments described above and can be embodied in various manners with appropriate modification.

1. A data logger for collecting data acquired from a controlled device and saving the collected data in storage media; the data logger comprising:
a plurality of storage media; and
a data collection processing unit that collects the data from outside on a regular basis or at predetermined timing, wherein
the data collection processing unit includes
a data acquisition processing unit that acquires the data from the outside, and
a data saving processing unit that saves the data acquired by the data acquisition processing unit in any of the plurality of storage media in accordance with an attribute based on types of the data.

2. The data logger according to claim 1, wherein
the data collection processing unit further includes a storage media designation processing unit that designates storage media out of the plurality of storage media in which the data acquired by the data acquisition processing unit are to be saved in accordance with the attribute based on the types of the data, and
the data saving processing unit is configured to save the data in the storage media designated by the storage media designation processing unit.

3. A data logger system comprising the data logger, the controlled device and the controller that controls the controlled device as recited in claim 1, wherein
the controller includes
a buffer, and
a data storage processing unit that acquires the data from the controlled device, adds an attribute, based on the types of the acquired data, to the data, and stores the data in the buffer,
the data acquisition processing unit is configured to acquire the data stored in the buffer, and
the data saving processing unit is configured to save the data in any of the plurality of storage media in accordance with the attribute added to the data by the data storage processing unit.
